(19) United States
(12) Patent Application Publication
(10) Pub. No.: US 2007/0169404 A1
(43) Pub. Date: Jul. 26, 2007

(54) Candle made from multiple wax materials with different melting points

(75) Inventor: John Cagle, Greenfield, MA (US)

Correspondence Address: WILMER CUTLER PICKERING HALE AND DORR LLP, 60 STATE STREET, BOSTON, MA, 02109, US

(73) Assignee: The Yankee Candle Company, Inc., So. Deerfield, MA (US)

(21) Appl. No.: 11/338,264

(22) Filed: Jan. 24, 2006

(51) Int. Cl. C11C 5/00

(52) U.S. Cl. 44/275

(57) ABSTRACT

A scented candle includes at least two different wax materials with one of the materials having one melting point and at least one of the other wax materials having a second higher melting point. The wax having the higher melting point may include a fragrance that is different from the other wax materials in the candle. The second fragrance may also be at a much higher concentration than the fragrances in the other wax materials contained in the candle. The wax having the higher melting point may also include odor abatement substances.

### BACKGROUND OF THE INVENTION

The present invention relates to scented candles and more particularly to a scented candle having at least two types of wax with different melting points.

With the increasing popularity of scented candles, consumer demand has risen for candles having a combination of a variety of fragrances. In some cases, wax has been layered or swirled in a candle so that two different types of wax are visible, generally through the glass enclosure for the candle but also by viewing the top of the candle. As the candle burns, the scents of both waxes are released to provide this blended scent. For example, The Yankee Candle Company sells a candle under the name Cranberry Peppermint and that candle will provide the scent of both cranberry and peppermint as it burns.

In many known candles having multiple waxes with different fragrances, the waxes containing the various scents each have the same melting point so that both scents are released as the wax melts. In some cases, the waxes are arranged in the candle so that there is more wax containing the predominant scent or so that one scent is released at a different time then another scent in the candle. In addition, other technologies have been developed in recent years that actually remove odors from the air and to make the scent of the candle more effective. Such technology is often referred to as an odor abatement system.

In U.S. Pat. No. 4,028,045 issued to Reiher, a candle is described that is made from two different wax compositions with the wax making up the main body of the candle having a higher melting point than the wax included in a wax insert. This candle was designed to address the problem caused by the fragrance material included in the scented candles reducing the melting point of the wax and also softening the wax. By placing the wax with the higher burning point and harder composition around a scented wax composition with the lower melting point, the candle was better able to maintain its integrity. The candle described in this patent, however, does not have any fragrance in the outer wax material because Reiher sought to avoid the softening of such wax material that results from such a combination.

It is a principal object of the present invention to provide a candle in which the release of fragrance can be controlled through the use of wax having more than one melting point.

Another object of the present invention is to provide a scented candle that also makes use of an odor abatement system.

### SUMMARY OF THE INVENTION

The present invention is a scented candle that includes at least two different wax materials with one such wax material having one melting point and at least one of the other wax materials having a second melting point. In some embodiments, the wax having the higher melting point includes a fragrance that is different from the fragrance in the other wax materials in the candle. In other embodiments the second fragrance is at a much higher concentration than the fragrances in the other wax materials contained in the candle. In still further embodiments the wax composition having the higher melting point includes odor abatement additives.

### BRIEF DESCRIPTION OF THE DRAWINGS

FIG. 1 is a perspective view of a candle of the present invention having two wax materials.

FIG. 2 is a cross section of the candle of the present invention shown in FIG. 1.

FIG. 3 is a top plan view of a wick positioning device used in the manufacture of the candle of the present invention shown in FIG. 1.

FIG. 4 is a cross section of a candle of the present invention shown in FIG. 1 in the process of being manufactured.

### DETAILED DESCRIPTION OF PREFERRED EMBODIMENTS

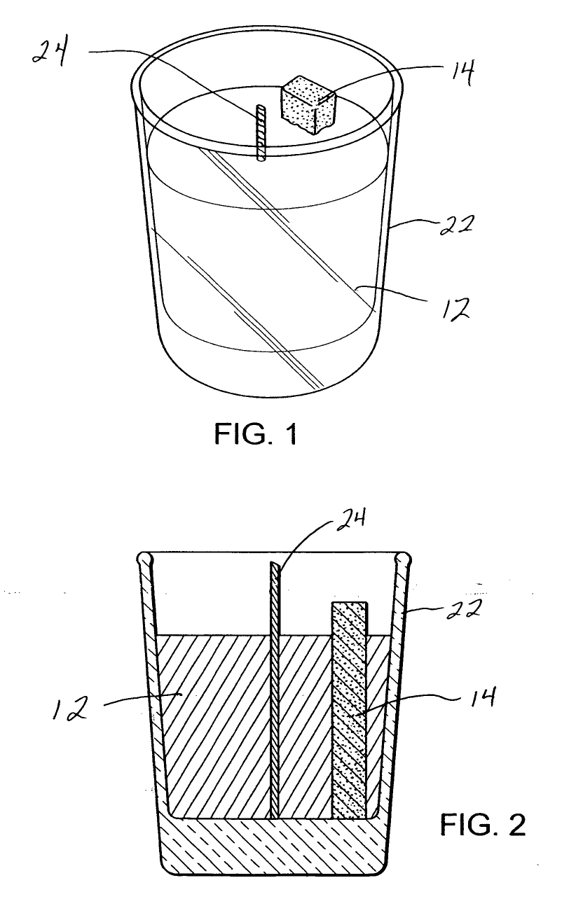

With reference to FIGS. 1 and 2, a candle 10 is shown having two different wax compositions. A first wax material 12 has a first melting point, which in a preferred embodiment is between 120° F. and 135° F. A second wax material 14 has a higher melting point, which is preferably between 148° F. and 160° F. In other embodiments the candle may contain more than two wax compositions with multiple melting points to achieve the desired effects. In the embodiment shown in FIGS. 1 and 2, the wax material 14 is shown in a stick configuration that extends through the body of the candle 10. This stick configuration of wax 14 provides a visual cue to the user of the candle to indicate the level of wax remaining in the candle.

In a preferred embodiment of the present invention the wax material 12 has a first concentration of fragrance and the wax material 14 has a higher level of a second fragrance. As the candle burns the candle emits the initial fragrance and when the higher melting point is reached, the second wax material 14 begins to melt and the second fragrance becomes the predominant fragrance in the candle.

In an alternate embodiment of the present invention the wax material 14 includes an odor abatement substance. A suitable odor abatement material is sold by Givaudan Inc. of Teaneck, N.J. under the trademark NEUTRAQ. This odor abatement material would preferably be incorporated into the wax material 14 in order to remove odors from the air other than the scent being emitted by the candle. The NEUTRAQ odor abatement material is also described in United States Published Application No. US2004/0248762 that was published on Dec. 9, 2004. This odor abatement material binds with Amines, thiols, sulfides, and other malodor molecules that are not found in fragrance raw materials. Thus, NEUTRAQ can exist in the candle body 12 or the higher temperature wax insert 14 or both.

In certain embodiments, the color of the wax material 14 is different than the color of the other wax 12 in the candle.

In a preferred embodiment, the candle 10 is manufactured by mixing together high melt point fully refined paraffin, broad cut microcrystalline wax, hyperbranched polymer, a fragrance or odor abatement material, ultra violet light stabilizers, antioxidants and pigments. These materials are mixed and melted into a homogenous liquid state creating a molten “blend”. A molten blend is then sprayed into the air via nozzles with an orifice of 0.35 mm or 0.4 mm onto a rotating cold drum where it forms small spheres (approximately 0.25 mm-1.25 mm in diameter). The small spheres are scraped off the cold drum into a vibrating pan and collected at a point of vacuum. The vacuum delivers small spheres into a candle excursion molding machine, such as the machine sold by Herrhammer, GmbH under Model No. STFM-1/450/3. The small spheres are compressed under pressure to form an extruded solid wax blend. The extruded solid wax blend is split into a number of extruded wax blend pieces 14 upon exiting the machine in the desired width and depth.

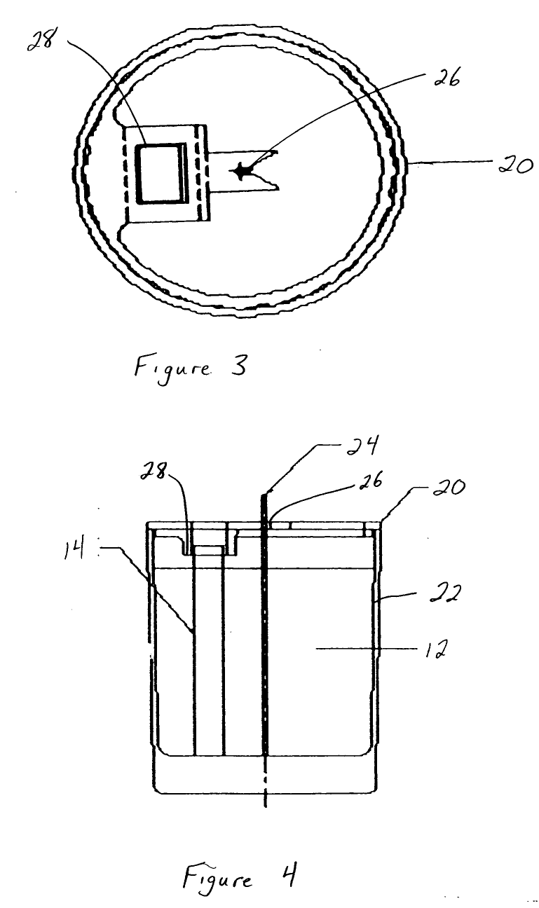

The main candle body 12 has a melting point of between 120° F. and 135° F. Referring to FIGS. 3 and 4, a wick centering and wax insert positioning device 20 is placed immediately on top of an opened container 22. While the candle body is liquid, a wick 24 is pulled into the central opening 26 in the wick centering device 20 and held taut. The wax material 14 of the higher melting point is then inserted through an opening 28 in the wick centering device 20 that will accurately and consistently place the wax stick 14 parallel to the wick 24. The difference in melting points between the candle body wax material 12 and the insert wax material 14 allows for a placement of the wax material 14 in a liquified wax body 12 without jeopardizing the integrity of the wax material 14. The candle body is cooled to complete solidification and subsequently topped off with additional wax in an effort to create a level end-use product. The wick centering device 20 is then removed and the wick 24 is cut to an appropriate length.

While the foregoing invention has been described with reference to its preferred embodiments, various alterations and modifications will occur to those skilled in the art. All such alterations and modifications are intended to fall within the scope of the appended claims.

What is claimed is:

1. A candle comprising:
a first wax material having a first melting point;
a second wax material having a second melting point, said second melting point being higher than said first melting point, said second wax material being position at least partially within said first wax material;
wherein when said candle is used said first wax material melts before said second wax material.

2. The candle of claim 1 wherein said first wax material and said second wax material each further comprise a fragrance.

3. The candle of claim 2 wherein said fragrance in said second wax material is at a higher concentration than the concentration of said fragrance in said first wax material.

4. The candle of claim 1 wherein said second wax material further comprises an odor abatement material.

5. The candle of claim 1 wherein said first wax material comprises a color pigment of a first color and said second wax material comprises a color pigment of a second color wherein said first and second colors are different.
